(19) United States
(12) Patent Application Publication
(10) Pub. No.: US 2022/0001838 A1
(43) Pub. Date: Jan. 6, 2022

(54) VEHICLE AND CONTROL METHOD THEREOF

(71) Applicants: HYUNDAI MOTOR COMPANY, Seoul (KR); KIA MOTORS CORPORATION, Seoul (KR); YURA CORPORATION CO.,LTD., Seongnam-si (KR)

(72) Inventors: Jeong-gi YUN, Seoul (KR); Taewon Lim, Yongin-si (KR)

(73) Assignees: HYUNDAI MOTOR COMPANY, Seoul (KR); KIA MOTORS CORPORATION, Seoul (KR); YURA CORPORATION CO.,LTD., Seongnam-si (KR)

(21) Appl. No.: 17/104,819

(22) Filed: Nov. 25, 2020

(30) Foreign Application Priority Data
Jul. 6, 2020 (KR) 10-2020-0083093

(51) Int. Cl. B60R 25/40; B60L 58/18; B60L 58/12

(52) U.S. Cl. CPC B60R 25/403; B60L 58/12; B60L 58/18

(57) ABSTRACT

The present disclosure provides a vehicle capable of locking/unlocking a vehicle door through a remote controller even when the vehicle's main battery cannot supply power normally. A vehicle includes: a door locking device configured to perform locking/unlocking of the door; and a controller configured to drive the door locking device using the power of a first battery, charge a second battery with the power of the first battery, and drive the door locking device using the power of the second battery when power is not supplied from the first battery.

### CROSS-REFERENCE TO RELATED APPLICATION

This application claims priority to and he benefit of Korean Patent Application No. 10-2020-0083093, filed on Jul. 6, 2020 in the Korean Intellectual Property Office, the entire contents of which are incorporated herein by reference.

### FIELD

The disclosure relates to a vehicle, and to a locking/unlocking of the door locking device of the vehicle.

### BACKGROUND

The statements in this section merely provide background information related to the present disclosure and may not constitute prior art.

Vehicle remote controllers include vehicle key fob or mobile communication terminals equipped with various functions. The user can unlock the vehicle door and trunk and start the engine using a remote controller. The key fob type remote controller allows the user to perform the aforementioned various operations simply by carrying the remote controller, which is based on wireless communication between the vehicle and the remote controller.

In order to use the remote controller, power must be secured for driving related devices including communication between the vehicle and the remote controller, user authentication, and electrical drive of the door locking device.

### SUMMARY

The present disclosure provides a vehicle capable of locking/unlocking a vehicle door through a remote controller even when the vehicle's main battery cannot supply power normally.

In accordance with one aspect of the disclosure, a vehicle includes: a door locking device configured to perform locking/unlocking of the door; and a controller configured to drive the door locking device using the power of a first battery, charge a second battery with the power of the first battery, and drive the door locking device using the power of the second battery when power is not supplied from the first battery.

The controller may include: a first controller configured to drive the door locking device using power of the first battery when power is supplied from the first battery; and a second controller configured to control charging of the second battery when power is supplied from the first battery, and control driving of the door locking device when power is not supplied from the first battery.

The vehicle may further include: a related controller configured to perform communication with a remote controller provided to remotely lock/unlock the door locking device, and the related controller may be configured to receive power from the first battery when power is supplied from the first battery, and receive power from the second battery when power is not supplied from the first battery.

The controller may be configured to control the power supply to the related controller and user authentication by performing boost control of the second battery in response to an emergency operation signal generated when power is not supplied from the first battery.

The door locking device may include a door latch configured to be mechanically operated by a driving force of a motor to engage in locking/unlocking of the door, and the motor may be configured to be driven by the power of the first battery or the power of the second battery.

In accordance with one aspect of the disclosure, a control method of a vehicle including a door locking device configured to perform locking/unlocking of the door includes: driving the door locking device using the power of a first battery; charging a second battery with the power of the first battery; and driving the door locking device using the power of the second battery when power is not supplied from the first battery.

The vehicle may further include a related controller configured to communicate with a remote controller provided to remotely lock/unlock the door locking device, and the control method may further include: supplying power of the first battery to the related controller when power is supplied from the first battery and supplying power of the second battery to the related controller when power is not supplied from the first battery.

The vehicle may further include a door latch configured to be mechanically operated by a driving force of a motor to engage in locking/unlocking of the door, and the motor may be configured to be driven by the power of the first battery or the power of the second battery.

In accordance with one aspect of the disclosure, a vehicle include: a door locking device configured to perform locking/unlocking of the door; and a controller configured to drive the door locking device using the power of a first battery, determine a target charging amount of the second battery based on a charging amount of the first battery when charging the second battery with the power of the first battery, and drive the door locking device using the power of the second battery when power is not supplied from the first battery.

The controller may be configured to increase the target charging amount of the second battery as the charging amount of the first battery decreases and decrease the target charging amount of the second battery as the charging amount of the first battery increases.

The controller may be configured to determine the target charging amount of the second battery by applying the smallest reference value among a plurality of preset reference values when the engine of the vehicle is turned on.

The controller may include: a first controller configured to drive the door locking device using power of the first battery when power is supplied from the first battery; and a second controller configured to control charging of the second battery when power is supplied from the first battery, and control driving of the door locking device when power is not supplied from the first battery.

The vehicle may further include: a related controller configured to perform communication with a remote controller provided to remotely lock/unlock the door locking device, and the related controller may be configured to receive power from the first battery when power is supplied from the first battery, and receive power from the second battery when power is not supplied from the first battery.

The controller may be configured to control the power supply to the related controller and authenticate a user by performing boost control of the second battery in response to an emergency operation signal generated when power is not supplied from the first battery.

The door locking device may include a door latch configured to be mechanically operated by a driving force of a motor to engage in locking/unlocking of the door, and the motor may be configured to be driven by the power of the first battery or the power of the second battery.

In accordance with one aspect of the disclosure, a control method of a vehicle including a door locking device configured to perform locking/unlocking of the door includes: driving the door locking device using the power of a first battery; determining a target charging amount of the second battery based on a charging amount of the first battery when charging the second battery with the power of the first battery; and driving the door locking device using the power of the second battery when power is not supplied from the first battery.

The determining the target charging amount may include: increasing the target charging amount of the second battery as the charging amount of the first battery decreases; and decreasing the target charging amount of the second battery as the charging amount of the first battery increases.

The determining the target charging amount may include: determining the target charging amount of the second battery by applying the smallest reference value among a plurality of preset reference values when the engine of the vehicle is turned on.

The vehicle may further include a related controller configured to communicate with a remote controller provided to remotely lock/unlock the door locking device, and the control method may further include: supplying power of the first battery to the related controller when power is supplied from the first battery and supplying power of the second battery to the related controller when power is not supplied from the first battery.

The control method may further include: controlling to the power supply to the related controller and authenticating a user by performing boost control of the second battery in response to an emergency operation signal generated when power is not supplied from the first battery.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

These and/or other aspects of the disclosure will become apparent and more readily appreciated from the following description of various forms of the present disclosure, taken in conjunction with the accompanying drawings of which:

FIG. 1 is a view illustrating a vehicle according to one form of the present disclosure;

FIG. 2 is a view illustrating a control system of a vehicle according to one form of the present disclosure;

FIG. 3 is a diagram illustrating an operation of a control system when a main battery of a vehicle is normally operated according to one form of the present disclosure;

FIG. 4 is a diagram illustrating an operation of a control system when a main battery of a vehicle does not operate normally according to one form of the present disclosure;

FIG. 5 is a diagram illustrating a method of charging a backup battery of a vehicle according to one form of the present disclosure;

FIG. 6 is a graph illustrating charging of a backup battery of a vehicle according to one form of the present disclosure; and

FIG. 7 is a diagram illustrating a vehicle control method when a main battery of a vehicle does not operate normally according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

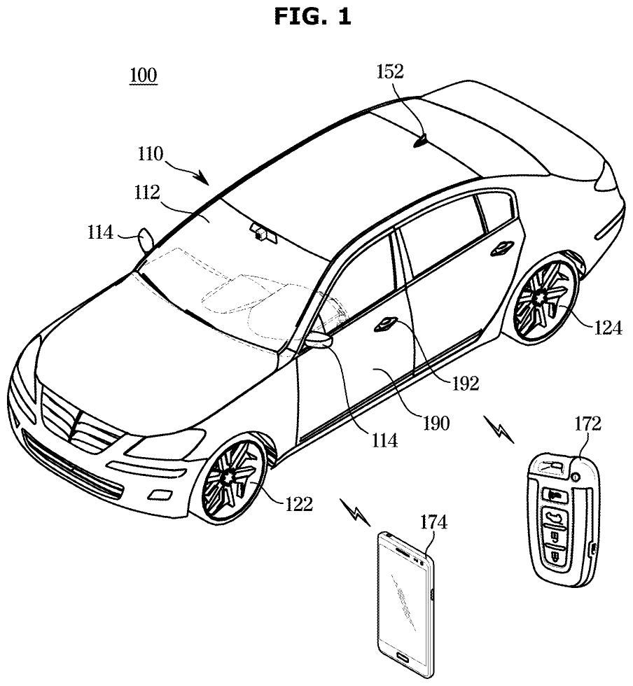

FIG. 1 is a view illustrating a vehicle according to one form of the present disclosure. The vehicle 100 shown in FIG. 1 externally has the following structure.

The windshield 112 is provided on the front upper side of the main body 110 to provide a front view to the occupants inside the vehicle 100 and protect the occupants from the wind. The outside mirror 114 provides an occupant with a view of the side and rear sides of the vehicle 100. One outside mirror 114 may be provided on each of the left and right doors 190.

The door 190 is rotatably provided on the left and right sides of the main body 110 so that occupants can enter and exit when opened, and when closed, the interior of the vehicle 100 may be shielded from the outside. The door 190 may be locked/unlocked using a door locking device 192. The locking/unlocking of the door locking device 192 may include a method in which a user approaches the vehicle 100 and directly manipulates a button or a lever of the door locking device 192 and a method of remotely locking/unlocking using a remote controller 172, 174 or the like at a location away from the vehicle 100. The door locking device 192 includes a door latch mechanically involved in locking/unlocking the door 190, and the door latch is driven by a motor. That is, when electric power is supplied to the motor and the motor rotates, the door latch mechanically moves to lock or unlock the door 190.

The antenna 152 is for receiving telematics, broadcasting/communication signals such as DMB, digital TV, and GPS. The antenna 152 may be a multifunctional antenna for receiving various types of broadcast/communication signals or a single function antenna for receiving any one broadcast/communication signal.

The front wheels 122 and the rear wheels 124 are positioned at the front and rear sides of the vehicle 100, respectively, and are provided to rotate by receiving power from an engine (not shown). The remote controller 174 is a device through which the user can remotely control the vehicle 100 through an application (also known as ‘APP’) installed on the mobile communication terminal 174. Also, the remote controllers 172 may be a vehicle key fob 172 equipped with various functions. The user may unlock the door and trunk of the vehicle 100 and start the engine by using the remote controllers 172 and 174. The key fob type remote controller 172 allows a user to perform various operations mentioned above simply by carrying the remote controller 172, which is based on a wireless communication between the vehicle 100 and the remote controller 172. The remote controller 174 of the mobile communication terminal type allows a user to perform the aforementioned various operations through an application installed in the mobile communication terminal and short-range communication (for example, NFC technology). The key fob type remote controller 172 may use the vehicle 100 only when the user carries the key fob type remote controller 172. However, since it is not possible to prepare a large number of key fob-type remote controllers 172 for one vehicle 100, it acts as a limitation in terms of car sharing in which a number of users share the vehicle 100. In contrast, since the remote controller 174 in the form of a mobile communication terminal performs various operations of the vehicle 100 through an application and short-range communication technology, anyone who owns a mobile communication terminal may use the vehicle 100 through user authentication. Thus, it is no longer desired to secure a large amount of the key fob type remote controller 172 in terms of car sharing. However, we have discovered that, in order to use the remote controller 172, 174, power for driving related devices including communication between the vehicle 100 and the remote controller 172 and 174, user authentication, and electrical driving of the door locking device 192 should be secured.

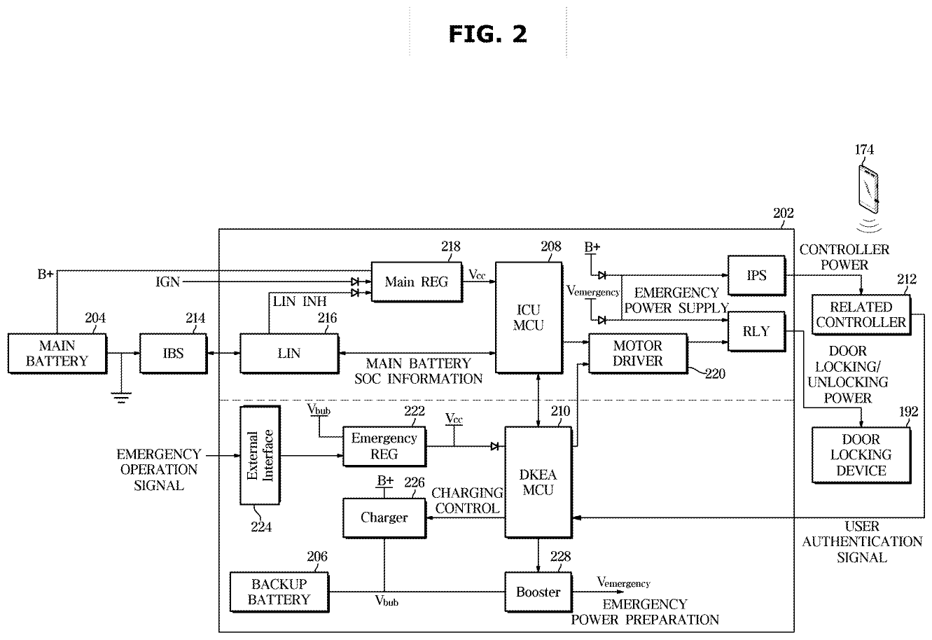

Therefore, in one form of the present disclosure, even in a situation in which the main battery (first battery) of the vehicle 100 (see 206 in FIG. 2) cannot supply power normally, a backup battery for locking/unlocking the door 190 of the vehicle 100 through the remote controller 172 and 174 and a control method thereof will be disclosed.

FIG. 2 is a view illustrating a control system of a vehicle according to one form of the present disclosure. Even in a situation where the main battery 204 of the vehicle 100 cannot supply power normally, the control system of the vehicle 100 shown in FIG. 2 is for locking/unlocking the door 190 of the vehicle 100 through the remote controller 172 and 174.

The integrated controller 202 receives a request from another controller and generates an output signal to operate the required function after processing through the control logic of the integrated controller 202 itself. When a door locking/unlocking request of the vehicle 100 according to one form of the present disclosure occurs, the integrated controller 202 controls the power required for door locking/unlocking to be supplied from either the main battery 204 or the backup battery (second battery) 206 according to the state of the main battery 204.

The integrated controller 202 of the vehicle 100 according to one form of the present disclosure includes a first controller (ICU MCU) 208 and a second controller (DKEA MCU, Digital Key Emergency Access MCU) 210. The first controller 208 controls to supply power required for door locking/unlocking from the main battery 204 when a door locking/unlocking request of the vehicle 100 according to the present disclosure is generated. When power supply from the main battery 204 is impossible, the first controller 208 cooperates with the second controller 210 to provide emergency power required for door locking/unlocking from the backup battery 206 to the door locking device 192 and the related controller 212. That is, the second controller 210 allows the backup battery 206 to generate emergency power required for door locking/unlocking when power supply from the main battery 204 is impossible. The related controller 212 is involved in communication with the remote controller 174 and user authentication. In this process, the related controller 212 may generate a user authentication signal.

The first controller 208 receives information on the main battery 204 detected through the battery sensor 214 through the LIN (Local Interconnect Network) transceiver 216. The information on the main battery 204 includes information on the state of charge (SOC) of the main battery 204.

The power B+ of the main battery 204 is converted to V_{cc} voltage through the main regulator 218 and supplied to the first controller 208. The main regulator 218 may operate in response to at least one of an engine start signal IGN and an INH signal of the LIN transceiver 216.

The first controller 208 supplies any one of power B+ of the main battery 204 and emergency power V_{emergency} of the backup battery 206 to the related controller 212 as controller power. In addition, the first controller 208 supplies any one of power B+ of the main battery 204 and emergency power V_{emergency} of the backup battery 206 to the door locking device 192 as door locking/unlocking power. When the door locking/unlocking power is supplied to the door locking device 192, the door locking device 192 is operated to perform locking/unlocking of the door 190 by driving the motor driver 220 under the control of the first controller 208.

The second controller 210 controls the charging of the backup battery 206 and the preparation of emergency power in response to the request of the first controller 208. The operating voltage V_{cc} of the second controller 210 is generated by converting the voltage V_{bub} of the backup battery 206 by the emergency regulator 222. The emergency regulator 222 operates in response to reception of an emergency operation signal input through the external interface 224. When the power supply from the main battery 204 is not normally performed, for example, when the main battery 204 is completely discharged or when the power of the main battery 204 is not supplied due to physical damage such as disconnection, an emergency operation signal may occur when a user operates a switch outside the vehicle to open and close the vehicle door.

The backup battery 206 is charged using the voltage B+ of the main battery 204. That is, when the second controller 210 generates a charge control signal, the charger 226 operates to charge the backup battery 206. The backup battery 206 is charged while the main battery 204 operates normally.

When an emergency operation signal occurs because the main battery 204 does not operate normally, the second controller 210 activates the booster 228 in response to the occurrence of an emergency operation signal, and the voltage V_{bub} of the backup battery 206 is boosted by the operation of the booster 228 to generate emergency power V_{emergency}. However, the second controller 210 generates emergency power V_{emergency} on the assumption that the user authentication signal of the related controller 212 is received.

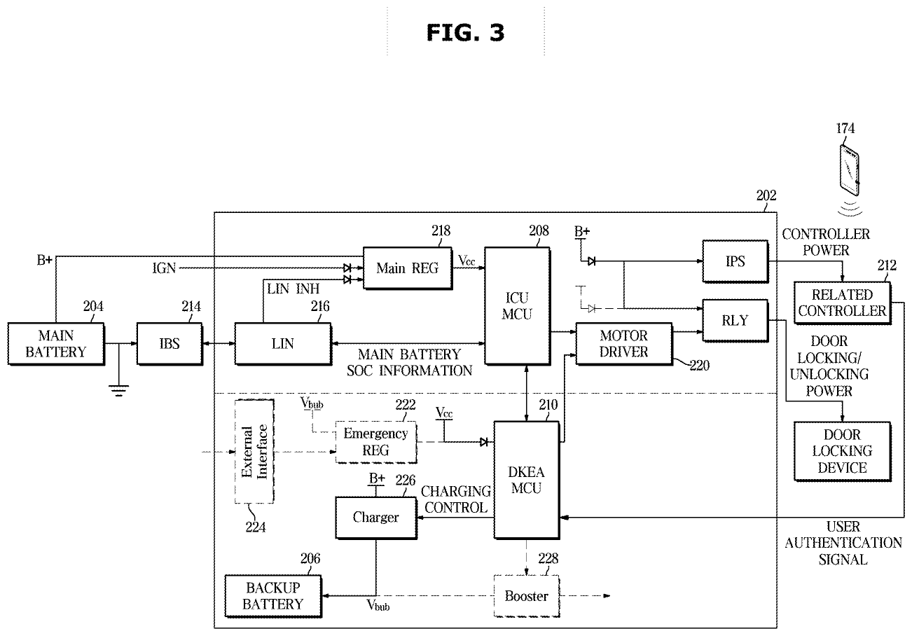

FIG. 3 is a diagram illustrating an operation of a control system when a main battery of a vehicle is normally operated according to one form of the present disclosure.

As shown in FIG. 3, when the main battery 204 of the vehicle 100 according to one form of the present disclosure operates normally, the power of the main battery 204 is normally supplied to the first controller 208 and the second controller 210, the motor driver 220, the related controller 212, the door locking device 192, and the like, and user authentication of the related controller 212 and the door locking device 192 is normally driven. That is, when the main battery 204 operates normally, locking/unlocking of the door locking device 192 is normally performed by using the power supplied from the main battery 204.

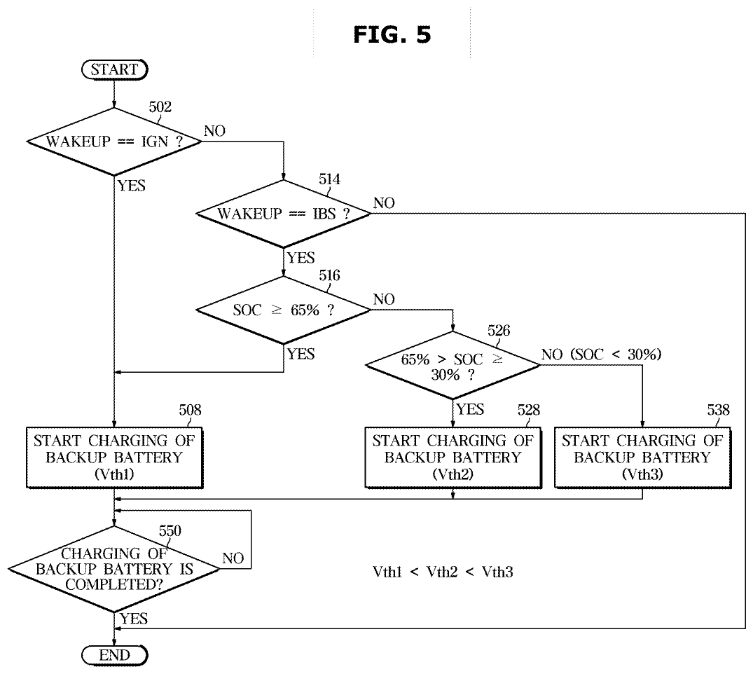

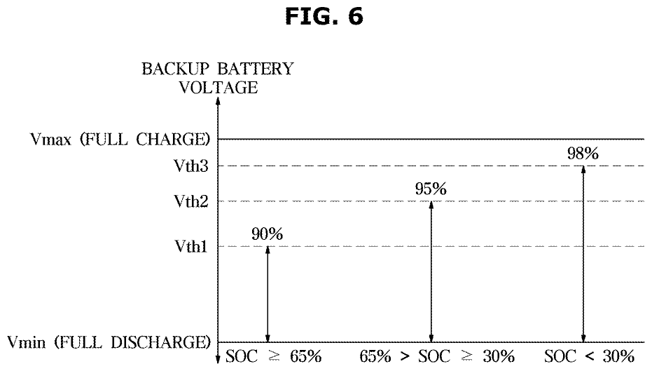

In addition, when the main battery 204 of the vehicle 100 according to one form of the present disclosure operates normally, the backup battery 206 is charged under the control of the second controller 210. That is, the power B+ supplied from the main battery 204 is transferred to the backup battery 206 through the charger 226, so that the backup battery 206 is charged. The second controller 210 determines the target charging amount of the backup battery 206 in consideration of the SOC of the main battery 204, which will be described in detail with reference to FIGS. 5 and 6 to be described later.

As can be seen in FIG. 3, when the main battery 204 of the vehicle 100 according to one form of the present disclosure operates normally, the external interface 224, emergency regulator 222, and booster 228 involved in the supply of emergency power V_{emergency} of the backup battery 206 are not activated.

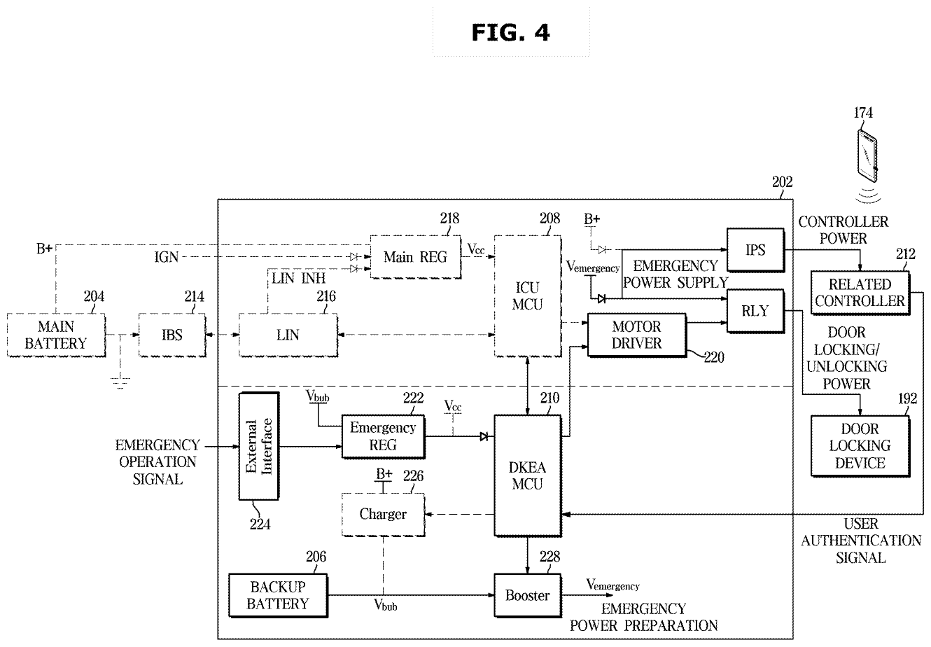

FIG. 4 is a diagram illustrating an operation of a control system when a main battery of a vehicle does not operate normally according to one form of the present disclosure.

As shown in FIG. 4, when power is not supplied from the main battery 204 due to complete discharge or disconnection (that is, when the main battery 204 does not operate normally), the first controller 208, the second controller 210, the related controller 212, and the door locking device 192 do not receive power (B+) from the main battery 204. Therefore, when the main battery 204 does not operate normally, locking/unlocking of the door locking device 192 controlled by the first controller 208 using the power B+ of the main battery 204 is not performed.

In the vehicle 100 according to one form of the present disclosure, when the main battery 204 does not operate normally, the user authentication of the related controller 212 and the driving of the door locking device 192 are performed normally by generating the emergency power V_{emergency} by boosting the power V_{bub} of the backup battery 206, and by supplying this emergency power V_{emergency} to the second controller 210 and the motor driver 220, the related controller 212, the door locking device 192. That is, when the main battery 204 operates normally, the backup battery 206 is charged with the power B+ of the main battery 204, when the main battery 204 does not operate normally, the locking/unlocking of the door locking device 192 of the vehicle 100 is controlled by using the power V_{bub} of the backup battery 206. Accordingly, even when the main battery 204 does not operate normally, locking/unlocking of the door locking device 192 may be performed normally through the operation of the backup battery 206 according to the present disclosure.

FIG. 5 is a diagram illustrating a method of charging a backup battery of a vehicle according to one form of the present disclosure. FIG. 6 is a graph illustrating charging of a backup battery of a vehicle according to one form of the present disclosure.

Previously, in the description of FIG. 3, it has been mentioned that the target charging amount of the backup battery 206 is determined in consideration of the SOC of the main battery 204. As can be seen from FIG. 5, in the vehicle 100 according to the present disclosure, the target charging amount of the backup battery 206 is applied differently depending on what percentage of the SOC of the main battery 204 is. For example, as the percentage of the state of charge (SOC) of the main battery 204 decreases, the target charging amount of the backup battery 206 increases. This will be described in detail as follows.

In FIGS. 5 and 6, reference values Vth1, Vth2, and Vth3 for determining the target charging amount of the backup battery 206 have a relationship of Vth1<Vth2<Vth3.

As shown in FIGS. 5 and 6, when the engine of the vehicle 100 is turned on (ING ON) (YES in 502), and the main battery 204 operates normally, the second controller 210 controls charging of the backup battery 206 by applying the smallest reference value Vth1 (508).

If the engine of the vehicle 100 is not turned on (IGN OFF) (NO in 502) and the main battery 204 does not operate normally, the second controller 210 confirms what percentage of the state of charge (SOC) of the main battery 204 detected through the battery sensor 214 is (YES in 514). In one form of the present disclosure, the state of charge (SOC) of the main battery 204 is divided into three sections: ‘SOC≥65%’, ‘65%>SOC≥30%’, and ‘SOC<30%’. The backup battery 206 is charged by applying a reference value of any one of Vth1, Vth2, and Vth3 according to which section of the three sections the SOC of the main battery 204 belongs to.

If the state of charge (SOC) of the main battery 204 is ‘SOC≥65%’ while the engine of the vehicle 100 is turned off (YES in 516), the second controller 210 controls charging of the backup battery 206 by applying the smallest reference value Vth1 (508). When the engine of the vehicle 100 is turned on, the main battery 204 may be sufficiently charged, and even when the engine is turned off, if the state of charge (SOC) of the main battery 204 is ‘SOC≥65%’, relatively sufficient power may be supplied from the main battery 204, in this case, the backup battery 206 is charged to 90% by applying the smallest reference value Vth1 (refer to the ‘SOC≥65%’ section in FIG. 6).

If the state of charge (SOC) of the main battery 204 is ‘65%>SOC≥30%’ when the engine of the vehicle 100 is turned off (YES in 526), the second controller 210 controls charging of the backup battery 206 by applying a reference value Vth2, which is an intermediate value between Vth1 and Vth3 (528). When the state of charge (SOC) of the main battery 204 is ‘65%>SOC≥30%’ while the engine of the vehicle 100 is turned off, since the backup battery 206 may receive a relatively stable level of power even if it is not sufficient from the main battery 204, in this case, the backup battery 206 is charged to 95% by applying the intermediate reference value Vth2 (refer to the ‘65%>SOC≥30%’ section in FIG. 6).

If the state of charge (SOC) of the main battery 204 is ‘SOC<30%’ while the engine of the vehicle 100 is turned off (No in 526), the second controller 210 controls charging of the backup battery 206 by applying the largest reference value Vth3 (538). When the state of charge (SOC) of the main battery 204 is ‘SOC<30%’ while the engine of the vehicle 100 is turned off, since the power that can be supplied from the main battery 204 is relatively insufficient, in this case, in order to actively utilize the backup battery 206 when an emergency occurs, the backup battery 206 is charged up to 98% by applying the largest reference value Vth3 (refer to the ‘SOC<30%’ section in FIG. 6).

As described above, in one form of the present disclosure, by adjusting the target charging amount of the backup battery 206 in consideration of the SOC of the main battery 204, when the power of the main battery 204 is not available, the backup battery (206) can be actively used.

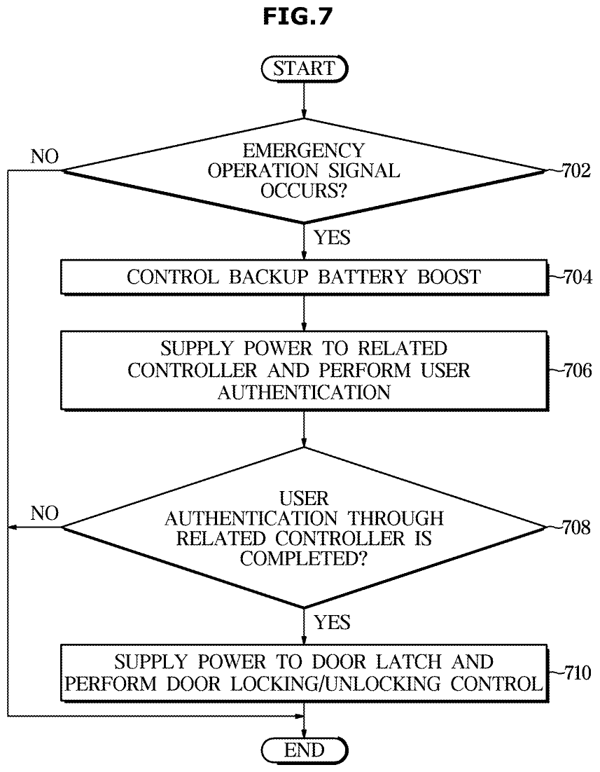

FIG. 7 is a diagram illustrating a vehicle control method when a main battery of a vehicle does not operate normally according to one form of the present disclosure.

As shown in FIG. 7, when the state of the main battery 204 detected by the battery sensor 214 is abnormal, an emergency operation signal occurs. When this emergency operation signal occurs and is input through the external interface 224 (YES in 702), the second controller 210 drives the booster 228 to boost the backup voltage V_{bub} of the backup battery 206 to a predetermined level, thereby generating emergency power V_{emergency} (704). The emergency power V_{emergency} generated in this way is supplied to the related controller 212 to prepare for the manipulation of the user's remote controller 172 and 174.

When power is being supplied to the related controller 212 and the user manipulates the remote controller 172 and 174 to open or close the door 190, the related controller 212 requests user authentication to the second controller 210 based on a signal received from the remote controller 172 and 174, and the second controller 210 performs user authentication on the authenticated user (706). When user authentication is completed (YES in 708), the second controller 210 allows the door locking device 192 to open or close by supplying power for door locking/unlocking to the door locking device 192 through the control of the motor driver 220 (710).

The above description is merely illustrative of the technical idea, and a person with ordinary knowledge in the technical field of the present disclosure will be able to make various modifications, changes, and substitutions within the range not departing from the essential characteristics. Accordingly, the disclosed forms and the accompanying drawings are not intended to limit the technical idea, but to describe the technical idea, and the scope of the technical idea is not limited by these forms and the accompanying drawings. The scope of protection should be interpreted by the scope of the claims below, and all technical ideas within the scope of the same should be construed as being included in the scope of the rights.

According to one aspect of the present disclosure, it is possible to lock/unlock the vehicle door through a remote controller even when the vehicle's main battery cannot supply power normally.

What is claimed is:

1. A vehicle comprising:
a door locking device configured to perform locking and unlocking of a door; and
a controller configured to:
drive the door locking device using power of a first battery,
charge a second battery with power of the first battery, and
drive the door locking device using the power of the second battery when power is not supplied from the first battery.

2. The vehicle according to claim 1, wherein the controller comprises:
a first controller configured to drive the door locking device using power of the first battery when power is supplied from the first battery; and
a second controller configured to control charging of the second battery when power is supplied from the first battery and control driving of the door locking device when power is not supplied from the first battery.

3. The vehicle according to claim 1, further comprising:
a related controller configured to:
communicate with a remote controller,
receive power from the first battery when power is supplied from the first battery, and
receive power from the second battery when power is not supplied from the first battery,
wherein the remote controller is configured to provide a communication to remotely lock and unlock the door locking device.

4. The vehicle according to claim 3, wherein the controller is configured to control power supplied to the related controller and authenticate a user by performing boost control of the second battery in response to an emergency operation signal generated when power is not supplied from the first battery.

5. The vehicle according to claim 1, wherein the door locking device comprises a door latch configured to be mechanically operated by a driving force of a motor, and
wherein the motor is configured to be driven by power of the first battery or power of the second battery.

6. A control method of a vehicle comprising a door locking device configured to perform locking and unlocking of a door, the method comprising:
driving the door locking device using power of a first battery;
charging a second battery with power of the first battery; and
driving the door locking device using power of the second battery when power is not supplied from the first battery.

7. The control method according to claim 6, further comprising:
supplying power of the first battery to the related controller when power is supplied from the first battery and supplying power of the second battery to the related controller when power is not supplied from the first battery,
wherein the vehicle further comprises a related controller configured to communicate with a remote controller provided to remotely lock and unlock the door locking device.

8. The control method according to claim 6, wherein:
the vehicle further comprises a door latch configured to be mechanically operated by a driving force of a motor, and
the motor is configured to be driven by power of the first battery or power of the second battery.

9. A vehicle comprising:
a door locking device configured to perform locking and unlocking of a door; and
a controller configured to:
drive the door locking device using power of a first battery,
determine a target charging amount of a second battery based on a charging amount of the first battery when charging the second battery with power of the first battery, and
drive the door locking device using power of the second battery when power is not supplied from the first battery.

10. The vehicle according to claim 9, wherein the controller is configured to increase the target charging amount of the second battery as the charging amount of the first battery decreases and decrease the target charging amount of the second battery as the charging amount of the first battery increases.

11. The vehicle according to claim 9, wherein the controller is configured to determine the target charging amount of the second battery by applying a smallest reference value among a plurality of preset reference values when an engine of the vehicle is turned on.

12. The vehicle according to claim 9, wherein the controller comprises:
a first controller configured to drive the door locking device using power of the first battery when power is supplied from the first battery; and
a second controller configured to control charging of the second battery when power is supplied from the first battery and control driving of the door locking device when power is not supplied from the first battery.

13. The vehicle according to claim 9, further comprising:
a related controller configured to:
communicate with a remote controller,
receive power from the first battery when power is supplied from the first battery, and
receive power from the second battery when power is not supplied from
the first battery,
wherein the remote controller is configured to provide a communication to remotely lock and unlock the door locking device.

14. The vehicle according to claim 13, wherein the controller is configured to control the power supply to the related controller and authenticate a user by performing boost control of the second battery in response to an emergency operation signal generated when power is not supplied from the first battery.

15. The vehicle according to claim 9, wherein the door locking device comprises a door latch configured to be mechanically operated by a driving force of a motor, and
wherein the motor is configured to be driven by power of the first battery or power of the second battery.

16. A control method of a vehicle comprising a door locking device configured to perform locking and unlocking of a door, the method comprising:
driving the door locking device using power of a first battery;
determining a target charging amount of a second battery based on a charging amount of the first battery when charging the second battery with power of the first battery; and
driving the door locking device using power of the second battery when power is not supplied from the first battery.

17. The control method according to claim 16, wherein determining the target charging amount of the second battery comprises:
increasing the target charging amount of the second battery as the charging amount of the first battery decreases; and
decreasing the target charging amount of the second battery as the charging amount of the first battery increases.

18. The control method according to claim 16, wherein determining the target charging amount of the second battery comprises:
applying a smallest reference value among a plurality of preset reference values when an engine of the vehicle is turned on.

19. The control method according to claim 16 further comprising:
supplying power of the first battery to the related controller when power is supplied from the first battery and supplying power of the second battery to the related controller when power is not supplied from the first battery,
wherein the vehicle further comprises a related controller configured to communicate with a remote controller provided to remotely lock and unlock the door locking device.

20. The control method according to claim 19 further comprising:
controlling power supply to the related controller and authenticating a user by performing boost control of the second battery in response to an emergency operation signal generated when power is not supplied from the first battery.
